(19) United States
(12) Patent Application Publication
(10) Pub. No.: US 2003/0126074 A1
(43) Pub. Date: Jul. 3, 2003

(54) System and method for allowing and making a monetary payment using communications network

(76) Inventors: Uwe Klatt, Berlin (DE); Thomas Ryll, Berlin (DE)

Correspondence Address: Kevin R. Spivak, Morrison & Foerster LLP, Suite 300, 1650 Tysons Boulevard, McLean, VA, 22102, US

(21) Appl. No.: 10/289,447

(22) Filed: Nov. 7, 2002

(30) Foreign Application Priority Data
Nov. 8, 2001 (EP) 01250394.2

(51) Int. Cl. G06F 17/60

(52) U.S. Cl. 705/39; 705/40

(57) ABSTRACT

The invention relates to a method for allowing a monetary payment using a first communications network, where a payment sender has access to a communications terminal which is associated with a first payment system in the first communications network, and where a payment receiver has an associated second payment system. The payment receiver transmits a payment message concerning the payment sender to the second payment system, and the second payment system recognizes that the payment sender is not associated with the second payment system. The second payment system then sends a request concerning the first payment system to a switching node which is connected to the first payment system, and this switching node sends an identifier for a communications link connecting the first and the second payment system to one of the payment systems in order to allow the communications link to be set up and to allow a subsequent monetary payment using the communications link.

### CLAIM FOR PRIORITY

This application claims priority to European Application No. 01250394.2 which was filed in the German language on Nov. 8, 2001.

### TECHNICAL FIELD OF THE INVENTION

The invention relates to a system and method for allowing and making a monetary payment using a communications network and to a system and method for communication between payment systems performing payment transactions in communications networks.

### BACKGROUND OF THE INVENTION

“Electronic Commerce” (E-Commerce), for example, involves the need to perform payment transactions using communications networks. Such payment transactions can arise, by way of example, when cost-incurring services or work (e.g. supply of information, data or goods) are provided over the communications networks. Communications networks of this type which are used are, by way of example, the Internet or telecommunications networks (mobile radio networks, landline networks). To pay for the services or work, methods are required for cashless payment using a mobile terminal (e.g. a mobile terminal, a laptop, personal digital assistant PDA or palmtop) and/or an Internet terminal (e.g. Internet computer), for example. Even away from “Electronic Commerce” and independently of the provision of services, however, methods of payment over communications networks are required, e.g. for donations. Often, payment receivers do not perform the relatively complex payment transactions themselves, but rather use payment service providers which operate payment systems for handling payment transactions. Such payment transactions thus often involve a payment sender (e.g. a customer or consumer), a payment receiver (e.g. a trader, service provider or merchant) and a payment system belonging to a payment service provider, with both the payment sender and the payment receiver using the services of the payment service provider.

### SUMMARY OF THE INVENTION

The present invention specifies a method which can be used as a simple and reliable way of allowing payments between a payment sender and a payment receiver, even if the payment service provider used by the payment sender is not known to the payment receiver, or vice versa.

In one embodiment of the invention, there is a method for allowing a monetary payment using a first communications network, where a payment sender has access to a communications terminal which is associated with a first payment system in the first communications network, and where a payment receiver has an associated second payment system, in which the payment receiver transmits a payment message concerning the payment sender to the second payment system, the second payment system recognizes that the payment sender is not associated with the second payment system, the second payment system sends a request concerning the first payment system to a switching node which is connected to the first payment system, and the switching node sends an identifier for a communications link connecting the first and the second payment system to one of the payment systems in order to allow the communications link to be set up and to allow a subsequent monetary payment using the communications link.

In one aspect of the invention, it is advantageous that the identifier for the communications link between the first and the second payment system is sent by the switching node. The second payment system therefore is not required to access the first payment system from the outset. This increases the first payment system's security against unwanted access. In addition, the management complexity is reduced for the second payment system, since it does not need to reserve any identifiers for payment systems.

In another embodiment of the invention, the method can be in a form such that setup of the communications link and communication via the communications link, particularly for the purpose of monetary payment, are effected on the basis of specifications called “Open Service Access/Parlay” (OSA/Parlay). A particular advantage in this context is that the method can involve the use of event sequences which are already known per se from OSA/Parlay specifications. Hence, the invention can be implemented with little complexity and very inexpensively.

In still another embodiment of the invention, the first payment system is connected to the first communications network, and the second payment system is connected to a second communications network, and the communications link can connect the first communications network and the second communications network. A particular advantage in this context is that the invention can also be used when the payment systems involved are situated in different communications networks.

In one aspect of the invention, the switching node used can be a switching node operating on the basis of “Open Service Access/Parlay” specifications (OSA/Parlay gateway). This has the particular advantage that a switching node in such a form can use security mechanisms which are available in OSA/Parlay technology to set up the communications link and to transmit data.

In yet another embodiment of the invention, the first payment system is registered with the switching node as a system which provides payment services, the second payment system requests a payment service when making the request, the identifier for the communications link is then produced and sent to the second payment system, and the second payment system sets up the communications link. A particular advantage is that the second payment system does not need to have detailed information about the first payment system when making the request, since the necessary information about the first payment system is known as a result of its having registered with the switching node.

In another embodiment of the invention, there is a method for making a monetary payment using the methods described above, in which the monetary payment is made by virtue of the first payment system prompting a payment sum to be debited from a payment account, successful debiting involving the transmission of a success message from the first payment system to the second payment system via the communications link, and the second payment system then transmitting a receiver success message to the payment receiver. A particular advantage in this context is that the use of the payment sender's (e.g. prepaid) payment account means that there is no risk of payment default for the payment receiver. In addition, this aspect of the invention makes it possible to use the “prepaid” credit accounts known for paying for call charges in telecommunications networks.

In still another embodiment of the invention, there is a method for making a monetary payment using the methods described above, in which the monetary payment is made by virtue of the first payment system prompting detection of the payment sum for the purpose of later settlement with the payment sender, successful detection involving the transmission of a success message from the first payment system to the second payment system via the communications link, and the second payment system then transmitting a receiver success message to the payment receiver. In one aspect, it possible to settle the payment sums with the payment sender after a time delay, using invoices. To this end, the invoicing systems known for telecommunications networks can be used by network operators, for example.

In still another embodiment of the invention, there is a method for communication between payment systems performing payment transactions in communications networks, in which communications links are set up between the payment systems, with specifications called “Open Service Access/Parlay” (OSA/Parlay) being used to set up the communications links and/or to communicate via the communications links. One advantage is that the communications links are set up and communication takes place using techniques which are already used per se for other purposes, which means that the inventive method can be implemented easily and particularly inexpensively.

In one aspect of the invention, the payment systems are connected to different communications networks, and the communications links connect a plurality of communications networks. This means that the payment systems can advantageously communicate even if these payment systems are situated in different communications networks.

In another aspect of the invention, communications links which allow a monetary payment only within a preselectable validity period are set up between the payment systems. This has the advantage that use of the validity period criterion increases the security of the invention, since, when the validity period over the communications links has expired, access (e.g. by unauthorized parties) to the payment systems via the communications link is prevented.

In still another aspect of the invention, the payment sender is formed by a service user using a service from a service provider, who forms the payment receiver.

In yet another aspect of the invention, communications links between the payment systems are set up which allow communication only within a preselectable validity period.

### BRIEF DESCRIPTION OF THE DRAWINGS

The invention is explained in detail below with reference to the drawings, in which:

FIG. 1 shows an exemplary embodiment of event sequences in accordance with the invention.

FIG. 2 shows another exemplary embodiment of event sequences in accordance with the invention.

### DETAILED DESCRIPTION OF THE INVENTION

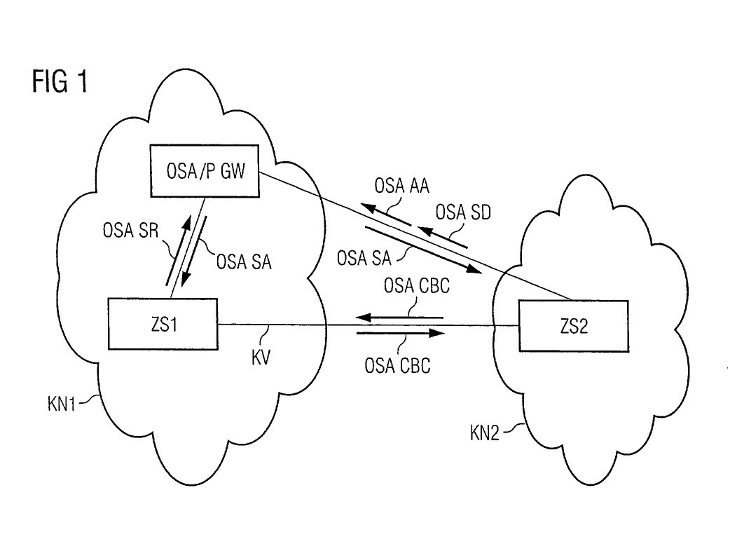

FIG. 1 shows event sequences in the invention, which are performed using “OSA/Parlay” technology. OSA/Parlay technology per se is known and is described, by way of example, in the printed documents “3GPP TS 29.198-3 V4.2.0(2001-09), Technical Specification, 3rd Generation Partnership Project; Technical Specification Group Core Network; Open Service Access (OSA); Application Programming Interface (API); Part 3: Framework (Release 4)”; “3GPP TS 29.198-12 V4.1.0 (2001-09) Technical Specification, 3rd Generation Partnership Project; Technical Specification Group Core Network; Open Service Access (OSA); Application Programming Interface (API); Part 12: Charging; (Release 4)” and in the printed document “3GPP TS 22.127 (V5.1.1 (2001-10); 3rd Generation Partnership Project; Technical Specification Group Services and System Aspects; Service aspects; Stage 1 Service Requirement for the Open Service Access (OSA) (Release 5)”. Information regarding the organization “3GPP” can be found on the Internet at the Internet address http://www.3gpp.org.

The left-hand side of FIG. 1 shows a first communications network KN1, which can be a telecommunications network or part of the Internet, for example. The first communications network KN1 includes a first payment system ZS1 and a switching node OSA/P GW (OSA/P GW=Open Service Access/Parlay Gateway) connected to this first payment system ZS1. Such a switching node can be a switching node with an OSA/Parlay function (also referred to as OSA/Parlay Framework function); an example of such a switching node is an “OSA/Parlay gateway”. The switching node is used to prepare and set up a communications link between the first payment system ZS1 and a second payment system ZS2, which is associated with a second communications network KN2 (shown on the right-hand side of FIG. 1). The subsequent communication itself does not take place via the switching node, however, but rather via the communications link between the payment systems directly. The switching node has no further direct influence on this communication.

The payment systems can be situated in the respective communications networks—as shown in FIG. 1—e.g. they can form a network node in the communications networks. However, the payment systems can also exist independently of the communications networks and can merely be connected to them. Between the first payment system ZS1, the second payment system ZS2 and the switching node OSA/P GW, the method described below can be performed in the course of the invention.

The payment system ZS1 can register with the switching node OSA/P GW by performing “OSA Service Registration” (OSA SR). With this registration OSA SR, the first payment system registers on the OSA gateway OSA/P GW as a “Payment Capability Server” (that is to say as a computer which can perform payment services) and thus provides these payment services for stations interested in using services.

Such a station interested in using a service is the second payment system ZS2 in the second communications network KN2. This second payment system acts as an “OSA client” and, as such, contacts the switching node OSA/P GW. This involves the second payment system registering with the switching node OSA/P GW as an “OSA client”, and authentication and authorization are performed. This can be done, by way of example, by virtue of the second payment system transmitting a payment system identifier, already negotiated with the switching node beforehand, and an associated password to the switching node OSA/P GW. Similarly, digital signatures can be used for this, for example using a method known by the name “RSA”, from Rivest, Shamir and Adleman. This operation is shown in FIG. 1 by arrow OSA AA (OSA AA=OSA Authentication and Authorization).

Following successful authentication and authorization, the second payment system ZS2 sends a message to the switching node OSA/P GW which it uses to ask the switching node to indicate a particular service, in this case the service of the first payment system ZS1. To this end, the second payment system ZS2 assumes the role of an OSA client. The operation is shown symbolically in the figure by arrow OSA SD and is called “OSA Service Discovery” (=OSA SD). The switching node OSA/P GW informs the second payment system ZS2 about the presence of the first payment system ZS1, and the second payment system ZS2 asks the switching node to provide it with an object reference for setting up a communications link KV to the first payment system. The switching node OSA/P GW then uses the principles of object-oriented programming (OOP) to generate, in the first payment system ZS1, a (software) object for setting up the communications link KV and forwards an identifier for this object (namely the reference to this object) to the second payment system ZS2. The identifier can be protected against access by unauthorized parties when it is forwarded to the second payment system, for example by means of encryption. Using this identifier, the second payment system can set up the communications link KV to the first payment system. The operation of object generation and identifier forwarding is referred to as “OSA Service Access” and is shown symbolically in FIG. 1 by means of the arrows OSA SA (OSA SA=OSA Service Access).

When the communications link KV has been set up, messages allowing a monetary payment can then be interchanged between the first payment system ZS1 and the second payment system ZS2. In this context, the event sequences in a payment method described in the OSA specifications, called “OSA Content Based Charging”, can be used. “OSA Content Based Charging” can involve the use of the following payment variants:

Immediate Charging: direct withdrawal (debiting) of a sum of money from an account

Authorize & Capture: reservation of a sum of money in an account for a particular period of time and gradual debiting of partial sums in this reserved sum of money

Rate & Charge: this involves the second payment system not sending the first payment system a sum of money which is to be paid, but rather other variables which influence the payment (e.g. a volume of data which determines the level of payment or a transmission time which determines the level of payment). The first payment system can then use these variables to determine the level of the sum which is to be paid, as a result of which sums can be ascertained variably and flexibly.

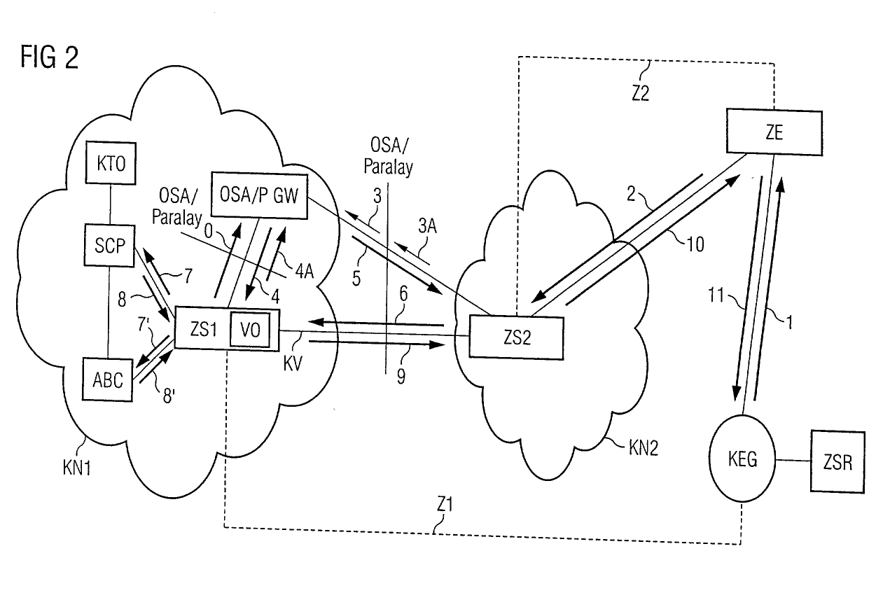

FIG. 2 shows the first communications network KN1 shown in FIG. 1, the first payment system ZS1 of a first payment service provider and the switching node OSA/P GW and also the second communications network KN2 and the second payment system ZS2 of a second payment service provider. The text below will describe a method for allowing a monetary payment and a method for making the monetary payment. Before the actual start of the method, the first payment system ZS1 registers on the switching node OSA/P GW as a device which provides services (as a “Service Capability Server”, which in this case provides payment services). The first payment system ZS1 thus performs OSA Service Registration (cf. FIG. 1) and is therefore known to the switching node OSA/P GW. This is shown symbolically in FIG. 2 by arrow 0. The example now described will involve a purchaser wishing to make a purchase from a trader, and for this purchase a monetary payment by the purchaser to the trader being made possible and being made. In this case, the purchaser represents a payment sender ZSR, who has access to a communications terminal KEG (e.g. by means of a mobile phone, a laptop or a palmtop). The payment sender ZSR normally handles his payments using the first payment system ZS1 of a payment service provider. The communications terminal KEG is therefore associated with the first payment system ZS1 in the first communications network KN1. The association is shown symbolically by the dashed line Z1. The trader represents a payment receiver ZE, who handles his payments using the second payment system ZS2. The second payment system ZS2 is therefore associated (association Z2) with the payment receiver ZE (or with his payment receiver communications terminal).

The payment sender ZSR now uses his communications terminal KEG to send a purchase message (arrow 1) to the payment receiver ZE in order to make the purchase. The payment receiver determines the price for the desired article being purchased and sends a payment message (arrow 2) to the second payment system ZS2. The payment receiver ZE has a contractual agreement with this second payment service provider on account of the fact that he often performs payment transactions using the second payment system ZS2 of the second payment service provider, which means that the second payment service provider is engaged by the payment receiver ZE immediately upon the payment message 2, using the second payment system ZS2. Often, a network operator in the second communications network KN2 takes on the role of a payment service provider, so that it suffices for the payment receiver to send the payment message to the network operator in the second communications network KN2. The second communications network KN2 can be, by way of example, the communications network which the payment receiver normally uses to set up his communications links (for example his chosen telecommunications network).

The payment message 2 sent to the second payment system ZS2 includes, inter alia, details about the payment sender ZSR. The second payment system ZS2 identifies (for example after searching through a database) that the payment sender ZSR (or his communications terminal KEG) is not associated with the second payment system ZS2, i.e. has not registered with the second payment system to date in order to use it for payments, for example.

However, from information about the payment sender which is delivered together with the payment message 2 (for example from the mobile radio call number MSISDN of his communications terminal KEG), the second payment system ZS2 recognizes that the payment sender is a subscriber in the first communications network KN1 and that, accordingly, this subscriber handles his payment transactions using the first payment system ZS1 in the first communications network KN1. However, it is likewise possible for the second payment system ZS2 to obtain this information in another way. By way of example, the second payment system ZS2 can have a database connected to it which includes information about potential payment senders and about the payment systems which they use and which are therefore associated with their communications terminals.

The second payment system ZS2 then sends a message 3 to the switching node OSA/P GW in the first communications network KN1, which switching node is connected to the first payment system ZS1, and performs authentication and authorization at this switching node (OSA authentication and authorization OAA, cf. FIG. 1). This is shown symbolically in FIG. 2 by arrow 3. The second payment system ZS2 acts as an OSA client in this context. Following successful authentication and authorization, the second payment system ZS2 sends a message 3A (request 3A) for performance of “OSA Service Discovery” (cf. FIG. 1) to the switching nodes OSA/P GW. It thus prompts the switching node to search for a payment service within the first communications network KN1.

On account of the OSA Service Registration (arrow 0), the switching node OSA/P GW knows the first payment system ZS1 in the first communications network KN1 to be a provider of payment services, and the switching node therefore makes preparations to make the payment services of the first payment system ZS1 available to the second payment system ZS2. To this end, the switching node OSA/P GW creates an object VO (VO=connection object; the principles of object-oriented programming are used; such a connection object represents a data and program structure) on the first payment system ZS1. This is shown symbolically by arrow 4. An identifier for this object (the reference to this object), which represents an identifier for the communications link to be set up between the first payment system ZS1 and the second payment system ZS2, is then transferred from the first payment system to the switching node OSA/P GW (arrow 4a). The switching node then forwards this identifier to the second payment system ZS2 (arrow 5). When the identifier has been transferred to the second payment system ZS2, subsequent setup of the communications link KV between the first payment system ZS1 and the second payment system ZS2 and then monetary payment are permitted.

Using the identifier (the object reference), the second payment system ZS2 can now use the first payment system ZS1 in the first communications network directly and can set up the communications link KV between the two payment systems and hence also between the two communications networks. Using the communications link KV, messages for transmitting the payment details can then be transmitted to the first payment system ZS1. In this exemplary embodiment, the monetary payment needs to be made using a method stipulated in the OSA specifications, called “Content Based Charging”. This specific monetary payment method involves the first payment system being instructed to withdraw a particular sum of money directly from an account. To this end, an OSA operation “directDebitAmountReq” is used. This “Content Based Charging” is to be understood only as an example, however, and other specific payment methods can also be carried out by the first payment system ZS1.

The first payment system ZS1 thus receives, with an instructive message (arrow 6), the request to charge a particular sum of money to the payment sender ZSR. The first payment system ZS1 then establishes (for example by interrogating a database associated with it) that the payment sender ZSR preferably settles his payments using a payment account associated with him in the form of a credit account (for example a “prepaid” account in the communications network KN1). The first payment system KS1 then forwards a payment request (arrow 7) to an intelligent node SCP (SCP =Service Control Point) in the first communications network KN1, which has an intelligent network IN structure. The service control point SCP has access to the payment account KTO of the payment sender ZSR and debits the appropriate sum of money from the account KPO. Upon successful debiting, the service control point SCP confirms this to the first payment system ZS1 using an appropriate informative message (arrow 8). The first payment system then sends a success message 9 to the second payment system ZS2 via the communications link KV. This is done, by way of example, using the operation “directDebitAmountRes” from the “OSA Content Based Charging” method.

In another embodiment, the second payment system ZS2 transfers a receiver success message 10 about the successful debit operation to the payment receiver ZE (in this case to the trader), who then sends information 11 to the communications terminal KEG of the payment sender ZSR informing the payment sender ZSR about successful payment and, by way of example, sending information about delivery of the purchased product or about the purchased or ordered service. If the payment sender has purchased informative data (for example information about market prices) from the payment receiver, then this informative data can also be sent directly with the informative message 11 to the communications terminal KEG of the payment sender ZSR as the purchased article.

If—as a departure from the method described hitherto—the first payment system ZS1 in the first communications network KN1 includes the information that the payment sender ZSR normally makes payments by invoice (and not using the payment account KTO, as described above), then the first payment system ZS1 can send a message 7′, similar to the message 7, to an invoice payment center ABC instead of to the service control point CSP. This prompts the invoice payment center ABC (ABC=Administration and Billing Center) to record the payment sum for later settlement with the payment sender. The invoice payment center ABC then produces an invoice at a later time and sends it to the payment sender ZSR. The invoice payment center ABC sends a message 8′, of similar structure to the message 8, to the first payment system ZS1 as soon (in real time) as the payment sum has been recorded, whereupon the method is continued in the known manner. In one aspect of the invention, it is possible for invoicing methods customary in many telecommunications networks also to be used for making the monetary payment for the inventive method.

To make the monetary payment, in one embodiment, banks or credit card organizations can also be used by virtue of the first payment system ZS1 sending appropriate messages to technical facilities for the banks or credit card organizations. The first payment system ZS1 can also perform currency conversions if the payment sender is using a different currency than the payment receiver.

The communications link set up by the second payment system ZS2 can be provided with a validity period. Such a validity period can be stipulated, by way of example, by virtue of the communications link being able to be used to transmit messages for allowing and making the monetary payment within a prescribed time interval (e.g. within the first 10 minutes after the communications link has been set up). The validity period can also be limited, by way of example, by the number of messages transmitted, however, e.g. the communications link can be in a form such that it respectively transmits only two messages from the first payment system to the second payment system, and vice versa.

The invention has a series of advantages: it allows monetary payments beyond the limits of communications networks. In particular, such monetary payments are permitted and made even when different communications networks have different payment systems installed in them and the parties involved in the monetary payment each use different ones of these payment systems. By using the “OSA/Parlay” specifications for setting up the communications link and for communication via the communications link between the payment systems, purely proprietary communication is avoided. Instead, smooth communication is made possible between different payment systems in different communications networks Furthermore, the mechanisms already known in OSA/Parlay technology can be used for the invention. Such mechanisms concern, by way of example, security-related procedures, such as the authentication and authorization explained in connection with FIG. 1 or options for securing data transmitted via communications links against unauthorized access and alteration. The use of such options already available in the OSA/Parlay technology to allow and make monetary payments between different payment systems (and even between different communications networks) as well permits an inexpensive method which can be implemented with little complexity.

It is likewise advantageous that no permanent communications link need exist between the payment systems involved, but rather that the communications link is set up when required. This increases security against unauthorized access for the payment systems involved.

It is also particularly advantageous that, when the communications link has been set up, communication does not need to be handled via the switching node (the switching node thus does not need to undertake a “relay” function); instead, the payment systems can communicate directly with one another via the communications link.

This allows a high communication speed and a high data transfer rate.

What is claimed is:

1. A method for allowing a monetary payment using a first communications network, where a payment sender has access to a communications terminal which is associated with a first payment system in the first communications network, and where a payment receiver has an associated second payment system, comprising:
transmitting a payment message about the payment sender to the second payment system, the second payment system recognizing that the payment sender is not associated with the second payment system;
sending a request about the first payment system to a switching node which is connected to the first payment system; and
sending an identifier a communications link connecting the first payment system and the second payment system to one of the payment systems to configure the communications link and to allow a subsequent monetary payment using the communications link.

2. The method as claimed in claim 1, wherein configuration of the communications link and communication via the communications link are effected on the basis of specifications called “Open Service Access/Parlay”.

3. The method as claimed in claim 1, wherein the first payment system is connected to the first communications network, and the second payment system is connected to a second communications network, and the communications link is configured to connect the first communications network and the second communications network.

4. The method as claimed in claim 1, wherein the switching node used is a switching node operating on the basis of “Open Service Access/Parlay” specifications (OSA/P GW).

5. The method as claimed in claim 1, wherein
the first payment system is registered with the switching node as a system which provides payment services,
the second payment system requests a payment service when making the request,
the identifier for the communications link is produced and sent to the second payment system, and
the second payment system sets up the communications link.

6. A method for making a monetary payment, comprising:
prompting a payment sum to be debited from a payment account;
debiting using transmission of a success message from a first payment system to a second payment system via a communications link; and
transmitting a receiver success message to a payment receiver.

7. A method for making a monetary payment, comprising: prompting detection of a payment sum for settlement with a payment sender;
detection using transmission of a success message from a first payment system to a second payment system via a communications link; and
transmitting a receiver success message to a payment receiver.

8. A method for communication between payment systems performing payment transactions in communications networks, comprising setting up communications links between the payment systems, with specifications being used to set up a communications links and/or to communicate via the communications links.

9. The method as claimed in claim 8, wherein the payment systems are connected to different communications networks, and the communications links connect a plurality of communications networks.

10. The method as claimed in claim 8, wherein communications links which allow a monetary payment within a preselectable validity period are set up between the payment systems.

11. A system for allowing a monetary payment using a first communications network, where a payment sender has access to a communications terminal in the first communications network, comprising:
a payment receiver transmits a payment message about the payment sender; and
a second payment system receives the payment message and recognizes that the payment sender is not associated with the second payment system, wherein
the second payment system sends a request about the first payment system to a switching node which is connected to the first payment system, and
the switching node sends an identifier for a communications link connecting the first payment system and the second payment system to one of the payment systems to allow the communications link to be set up and to allow a subsequent monetary payment using the communications link.
